(19) United States
(12) Patent Application Publication
(10) Pub. No.: US 2014/0263624 A1
(43) Pub. Date: Sep. 18, 2014

(54) Radio Frequency Powered Smart, Debit, and Credit Card System Employing A Light Sensor To Enable Authorized Transactions

(71) Applicant: NagralD Security, Inc., Los Angeles, CA (US)

(72) Inventor: Philippe Guillaud, Los Angeles, CA (US)

(21) Appl. No.: 13/912,160

(22) Filed: Jun. 6, 2013

Related U.S. Application Data
(63) Continuation-in-part of application No. 13/830,341, filed on Mar. 14, 2013.

(51) Int. Cl. G06K 19/073; G06K 5/00

(52) U.S. Cl. CPC G06K 19/07336; G06K 5/00
USPC 235/380; 235/492

(57) ABSTRACT

This invention provides an embedded light sensor in the card that controls whether the card can transmit card data when energized by an RF energy source. Certain smart, debit or credit cards energize internal component within the card when entering into certain RF energy fields. The use of a light sensor detects whether a predetermined light level exists. If the predetermined light level is reached, the card's logic assumes that the transaction is authorized and allows for transmission of the card's data to a card reader. If the predetermined light level is not reached, the card's logic assumes that the card is still in a purse or wallet and that the RF energy field is not related to card transactions or the RF energy field belongs to fraudulent parties who seek to capture the card's data in an unauthorized manner. As a fail-safe, the card's logic may send a signal to the card holder when transactions are attempted in low light conditions that require the card holder to touch a button on the card or input a code for the transaction to proceed.

### CLAIM OF PRIORITY

This application claims priority to U.S. patent application Ser. No. 13/830,341 filed on Mar. 14, 2013 titled “Dynamically Allocated Security Code System for Smart, Debit and Credit Cards” and is incorporated by reference.

### BACKGROUND OF THE INVENTION

1. Field of the Invention

This invention concerns the field of enhanced security features for smart, debit and credit cards as used in commerce. Specifically, a dynamically allocated security code is generated by the smart, debit or credit card which when analyzed by a payment processor or card issuing network approves or denies specific financial transaction from occurring thus reducing the risk of fraudulent activity with the card.

2. Related Art

Most of online fraud occurs due to thief of a valid debit or credit card Primary Account Number (“PAN”), expiration date and security code that are stolen from the card holder without their knowledge. Typically, this theft of card data is accomplished when a card holder visits a merchant and an unscrupulous merchant employee captures the card data for later resale while returning the actual card to the card holder. With cameras built into most of today's mobile phones, card information can easily be captured when the card holder passes the card to unscrupulous merchant employees. Once stolen, the card data information is often parked for a short period of time (e.g. several months) so that the card holder cannot determine the location where the card information was stolen. After a suitable period of time has elapsed, the data card information and codes can be used for e-commerce transaction and cardholder may never notice the fraudulent purchases unless close examination is made of the bank/credit card statement.

Another way that card data is stolen is from hackers who manage to penetrate the internal firewalls of merchants, thus stealing card data stored by the merchants. In both scenarios, the card holder is typically not aware that their card information was stolen and sold to a third party such as a criminal organization until fraudulent transactions start appearing on the card holder's monthly statements.

One way for banks and credit card processors to combat credit and debit card fraud is to use security codes. These security codes are known by a variety of types of acronyms. Credit cards typically employ a Card Verification Value (“CVV” or “CVV2”), also known as a Card Security Code (“CSC”), Card Verification Data (“CVD”), Card Verification Value Code (“CVVC”), Card Verification Code (“CVC” or “CVC2”), Verification Code (“V-code” or “V code”), Card Code Verification (“CCV”), or Signature Panel Code (“SPC”). These security codes using different terminology help implement enhanced security features for smart, debit and credit card transactions by providing increased protection for merchants against credit card fraud. While American Express places its security code on the front of the card, most smart, debit and credit cards place their security codes on the back of the card forcing thieves to copy this information as well as a further step to discourage and make it slightly more difficult for thieves to capture the smart, debit and credit card information.

The original purpose of implementing three or four digit security codes was to ensure that card holders had the card in hands when making purchases. With the advent of online shopping, an increasing number of merchants started to store the security codes on their servers to speed up the online transaction process as a way to enhance the shopping convenience of the customer. Unfortunately, capturing this information helps thieves when the merchant's card data is hacked by sophisticated hackers and the smart/debit/credit card information along with the stored security codes are stolen removing the necessity for the thief to have the smart, debit or credit card in their physical possession. Thus, the use of security codes as a way to reduce fraudulent transactions is thwarted by the merchants themselves in their attempt to make online purchases easier for the customer.

Additional limitations exist on the use of smart, debit and credit card security codes. The use of these security codes cannot protect against phishing scams where the card holder is tricked into entering the security code along with other card details via a fraudulent website. The growth in phishing is another reason why the use of security codes has reduced their real-world effectiveness as an anti-fraud device. For merchants who do not use security codes, their transactions are typically subjected to higher card processing costs and fraudulent transactions without security codes are more likely to be resolved in favor of the cardholder thus increasing the costs to the merchants.

Some smart, debit and/or credit cards may not have internal batteries and are powered by radio frequency energy (“RF energy”). Such cards operate using RF energy to power the card's internal microprocessor and related transmitter that transfers the card data such as the PAN, expiration date and cardholder's name to a wireless terminal. Certain disreputable people, years ago learned that they could use a portable or stationary wireless terminal and once near an unsuspecting card holder, could use a RF source to energize the smart, debit or credit card and extract the card data to a memory storage device. Later the stolen card data could be uploaded to a fake card or used in online transactions to commit fraudulent purchases.

Therefore, a need exists for smart, debit or credit card to restrict the transfer of sensitive card data when the card holder is not engaged in an authorized transaction. Also, a smart, debt or credit card could add additional functionality and security features by having a dynamically generating card security codes that periodically changes in order to stymie thieves from stealing the card information or rendering stolen data worthless in a short period of time after the theft of the card's security code data. A need also exists for a system a card issuer to support dynamically changing security codes so that financial transactions that take several weeks are not erroneously denied and identified as fraudulent because the card security code has changed during the time delay in processing the financial transaction for the card.

### SUMMARY

This invention provides an embedded light sensor in the card that controls whether the card can transmit card data when energized by an RF energy source. Certain smart, debit or credit cards energize internal component within the card when entering into certain RF energy fields. The use of a light sensor detects whether a predetermined light level exists. If the predetermined light level is reached, the card's logic assumes that the transaction is authorized and allows for transmission of the card's data to a card reader. If the predetermined light level is not reached, the card's logic assumes that the card is still in a purse or wallet and that the RF energy field is not related to card transactions or the RF energy field belongs to fraudulent parties who seek to capture the card's data in an unauthorized manner.

In a more sophisticated card, the absence of a sufficient amount of light detected by the light sensor may trigger an error message or otherwise provide a visual cue to the card holder indicating a problem with the light source. Upon receiving the error message or cue, the cardholder could input a PIN number into a keypad integrated into the card allowing for the transaction to because authorized and move forward.

Additional sophistication may support the dynamical generation of a security code for the smart, debit and credit cards as an enhanced methodology to thwart fraudulent use of these cards in financial transactions. The card internally may comprise additional components such as a processor connected to a viewable display powered by a battery where the processor is capable of generating security codes on a periodic basis. The card can generate the security code by encrypting certain data is a way that the card issuer as the same security codes so that when the security code is used in a financial transaction, the card issuer can ascertain whether the transaction is valid and authorized or potentially fraudulent.

An alternative embodiment for the dynamic generation of security codes, the card processor may call from a memory storage area on the card a security code from a list of encrypted security codes. The security code is then validated using the same methodology as a security code that was generated by firmware running on the processor.

Dynamically generated security codes typically have a life of a couple of weeks before the security code is changed. To prevent unwanted denials of transactions when the security code is changed, a time period window can be created on the card issuer's network that compares the card security code with the current valid security code stored on the card issuer's server as well as the previous security code in case the transaction was processed over a longer period of time than the life of the dynamically generated security code.

This may be accomplished by creating a mid-point sliding time window whose size is the length of the time allotted for the life of the security code. When the security code arrives at the card issuer's servers, the sliding window is created with the mid-point of the sliding time period window the date of arrival of the card's security code. The sliding time period window may encompass more than one time period representing the life of the card's security code. Therefore, the card issuer's network can analyze all the valid security codes to ascertain whether the correct card security code was assigned at the start of the financial transaction, but was delayed for some reason. This sliding time period window allows for the validation of these slowly processed financial transactions without unduly increasing the risk of fraudulent activity.

Other systems, methods, features, and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### DETAILED DESCRIPTION OF THE DRAWINGS

The components in the figures are not necessarily to scale, emphasis being placed instead upon illustrating the principles of the invention. In the figures, like reference numerals designate corresponding parts throughout the different views.

FIG. 1 is a rear view of a smart, debit or credit card illustrating a flexible display on the rear side of the card.

FIG. 2 is an internal view of a smart, debit or credit card illustrating internal and external components laminated within the card of an RF powered card.

FIG. 3 is an internal view of a smart, debit or credit card illustrating internal and external components laminated within the card.

FIG. 4 is a block diagram of a smart, debit or credit card interacting with a wireless card processing network where the card reader employs and generates RF energy to temporarily power the card.

FIG. 5 is a block diagram of a smart, debit or credit card with a light sensor controlling the transmission of card data to the card reader.

FIG. 6 illustrates an alternative embodiment where the card holder can manually override the light sensor in low light environments.

FIG. 7 is a block diagram of a display code sequence enabling the use of a dynamically generated security code where the card recalls from memory a stored list of security codes selected by a counter.

FIG. 8 is a block diagram of a display code sequence enabling the use of a dynamically generated security code based on time slots.

### DETAILED DESCRIPTION

This invention provides a dynamic allocation of a security code for a smart card, debit card or credit card. In an effort to thwart smart, debit and credit card fraud, this invent provides for the generation of dynamically allocated card security codes calculated by various means. These dynamically allocated security codes may be generated by: (1) a random number that is encoded by encrypting the bank card number, also known as the Primary Account Number (“PAN”), expiration date and service code with encryption keys typically called Card Verification Keys (“CVK”) known only to the card issuing bank or smart card provider; (2) a list of encrypted numbers assigned to a specific card and stored in the card's memory; or (3) periodically wirelessly transmitted from a card issuer's network and stored in a memory area on the card.

In the most simplistic form, a smart, debit or credit card 100 may contain a magnetic stripe 102, a display 104 and a light sensor 106, as well as internal components integrated into a card such as a processor, receiver, transmitter, and antenna (not shown). Some smart, debit and/or credit cards are powered by radio frequency energy (“RF energy”) provided by a card reader (not shown). Such cards operate using RF energy to power the internal card processor and related transmitter that transfers the card data such as the account number, expiration date and PIN security code to the wireless card reader terminal. However, because certain disreputable people, years ago learned that they could use a portable or stationary wireless terminal and once near an unsuspecting card holder, could use a RF source to energize the smart, debit or credit card and extract the card data to a memory storage device. Later the stolen card data could be uploaded to a fake card or used in online transactions to commit fraudulent purchases.

Thus, a light sensor 106 can be used to control whether the smart, debit or credit card transmits the card data once energized by the card reader. If the light sensor 106 senses a predetermined level of illumination, the card will transmit the card data. If the light sensor 106 does not detect the predetermined level of illumination, it is assumed that the card is still in the card holder's wallet or purse and that the RF energy is from a non-authorized source. If the card is used in a low light area such as a restaurant or bar, an integrated button 108 may be pressed during the transaction so that the card data can be transmitted to the card reader.

Other security features on the card may include a signature stripe 110 or a hologram 112. For even more enhanced security features, the card may include the dynamic generation of a security code as a way to overcome the shortcomings of a static, printed security code on the front or back of a smart, debit or credit card 100. The card may dynamically generate a new and different security code periodically and is displayed on the card. On the outside, card 100 looks very similar to today's smart, debit and credit cards in that it has a PAN number, expiration date, name of an individual or company embossed on the front of the card. The card 100 may also have a logo of an issuing bank or organization backing the card.

For a smart, debit or credit card 100 to dynamically generate security codes, the display 104 may be incorporated into the card's structure. For optimum results, this display 104 may be flexible so that it will handle the stresses generated by card use. Typically, the display 104 may show three or four digits, but a card issuer may adopt a larger code display capable of showing more than four digits. A touch sensitive control button 108 may be incorporated into the card 100 so that whenever the touch sensitive control button 108 is selected the security code is shown on the display 104. If the card has an internal battery, use of the touch sensitive control button 108 would preserve battery life as the display could be off until the card holder needs to generate the security code. Also, the card may generate a new security code without any action taken on behalf of the card holder based on the passage of a predetermined amount of time (e.g. a week, two weeks, a month, etc.) set by the card issuer.

FIG. 2 is an internal view of a smart, debit or credit card illustrating internal and external components laminated within the card. In its basic form, the smart, debit or credit card 200 may have an internal antenna 202 that powers an integrated microprocessor/controller 204, the light sensor 206 via path 208 and display 210. In an alternative embodiment, the light sensor 206 may have its own antenna 212 with which to receive power. The microprocessor/controller 204 may further comprise a memory location 214 to store the card data and algorithms for dynamically generated security code.

FIG. 3 is a block diagram of the hardware that may be used to implement the generation of dynamic security codes in a smart, debit or credit card 300. The card 300 may comprise some or all of the following components and functionality: a built in microprocessor/controller 302, battery 304, memory storage area 306 which may be located within the microprocessor/controller 302 or external of the microprocessor/controller 302, a flexible display 308, a touch sensitive button 310, a keypad 312, a first antenna 314 for receiving RF energy and sending and receiving data, a second optional antenna 316 for transmitting and receiving data, an internal clock (not shown) and a light sensor 318. The flexible display 308 may be constructed using an e-paper type display so that the flexible display 308 is always on and a security code, message or blank screen is always visible to the card holder when examined. If the card holder were to press the touch sensitive button 310 or the keypad 312, the card may be enabled to display the security code in the display 308.

The interaction of a fully functional smart, debit, or credit card could support fast transactions such as those at a gas pump or grocery store that employs an RF card reader to speed transactions as well as for use in transactions where the risk of fraud is substantially higher. When the card receives RF energy from an RF card reader, the card could automatically recognize the environment and proceed with a fast transaction. Once again, use of the light sensor 318 could help prevent unauthorized transactions from occurring by restricting the transmission of card data if the light sensor 318 does not detect a predetermined level of illumination. If added security is needed because of the potential for fraud, the RF card reader could ask the card holder to manually input the card holder's zip code of the billing address.

With the added functionality of an internal battery 304, the card 300 would enable the full functionality of the card when in use at a tap and go transaction such as use at a gas pump where speed and smoothness of the transaction is a major selling feature while supporting the dynamic generation of security codes if added security functionality is needed is an online transaction. In such an embodiment, the battery could directly power the both the microprocessor and the light sensor (not shown) or directly power the microprocessor and indirectly power the light sensor as shown in FIG. 3. In online transactions where the potential for fraudulent activity is higher, the internal battery 304 would power the microprocessor/controller 302 so that the security code could be dynamically generated. Such a scenario could occur when the tap and go card reader is partially functioning where a transaction could occur, but the card reader is not producing enough RF energy to power the components on the card. In such a scenario, the card's internal batter could power the card's components and the card data could be transmitted by an antenna (314 or 316) enabling the transmission of card data from the card to the card reader.

In non-wireless environments, the use of the touch sensitive control button 310 within the card 300 could indicate that the card holder desires a generation of a new security code. The card 300 would generate a new security code and show the security code in the card's display. The use of such a touch sensitive control button 310 would extend the battery life of the card 300 and would only energize or light up the display 308 specifically when the user seeks to use the card 300. The implementation of a key pad 312 could provide additional security requiring the card holder to insert a PIN on the key pad 312 before the security code is shown on the display 208. An additional security level could be added with the use of a key pad 312 by allowing the secure code algorithm to generate a correct security code when the correct PIN is input on the key pad 312 and the generation of an incorrect security code if an incorrect PIN is input on the key pad 312.

Another security enhancing feature could be the addition of a One Time Password (“OTP”) that would be delivered to the user via a text message sent to the card holder's mobile device for access to online banking. The OTP would not necessarily replace the user's password, but could be required as a third component (login name, password and security code). Since the card only has one display of typically 3 or 4 digits, the OTP could work whenever the user requires an OTP to be generated. When requested, a user would press on the touch sensitive control button 314 of the card 300 and a new OTP would be displayed on the display 308 for a limited time (e.g. 30 seconds or less). Once the OTP code was viewed for the predetermined time period, the security code would replace permanently the OTP on the display 308. Pressing the touch sensitive control button 310 a second time would generate another OTP and so on. Each OTP would be valid for a limited time or based on a counter.

Another embodiment may include the implementation of two distinct functions on the same card (e.g. distinct crypto keys for different functions). In the case of a two feature card such as the implementation of an OTP and a dynamically generated security code, two different crypto algorithms may be implemented or one algorithm for the OTP calculation and a list of security codes for the dynamically generated security code implemented with two separate crypto keys for each function. Therefore, it would be possible for a bank or card issuer to split the security responsibilities between two distinct departments such as online banking and payment processing.

As a way to ensure that a card holder does not mix up the OTP and dynamically generated security code, a solution could be implemented where the OTP utilizes a four digit code and the dynamically generated security code is shown with three digits. Every time a card holder pressed the touch sensitive control button 314, the card holder would see the four digits OTP displayed for predetermined amount of time, e.g. 30 seconds followed by the display the 3 digits dynamically generated security code.

The dynamic generation of security codes may be calculated or called from a list of security codes stored in the memory location 306 on the card 300. An alternative embodiment may allow for the transmission of a unique security code to a card holder's mobile device that is then input into the card via the key pad 312. These solutions present several implementation issues such as (1) how long the security code should be valid; (2) how the card will be authenticated by the card issuer or payment processor with the dynamically generated or recall of the security code from a list of codes stored in the card's memory; and (3) compliance with a variety of card use transaction scenarios such as online, mail order, multi suppliers' orders, fax processed orders, un-synchronized transactions and etc.

Typically, smart cards, debit cards and credit cards are manufactured by one vendor and sent to another vendor for imprinting the PAN number, card holder name and expiration date of the card. The uploading of the security codes maybe be accomplished by the card issuer or the vendor charged with imprinting the PAN number, card holder name and expiration date with a contact or contactless smart card chip or through the use of a built in RF antenna.

Use by the card manufacturer of the RF antenna as a methodology to increase the productivity of the card manufacturer generating the cards for the cardholder as a way to upload the initial storage on the card of the card information such as the PAN number, card holder name, expiration date of the card and in some instances the security code. In addition, the RF antenna embedded in the card may be used to download updated firmware for the internal card processor; to download updated algorithms for calculating the security codes; resynchronize the card with the card issuer's network or download an updated list of security codes sent by the card issuer's network into the memory, not just at the point in time that the card is manufactured or generated for the card holder but at any time including after the card is in the possession of the card holder.

Many card issuer networks are developing standards for the financial industry. EMV stands for the Europay, Master Card and Visa global standard for the interoperation of Integrated Circuit Cards (“IC Cards”) and IC Card point of sale terminals and Automated Teller Machines (“ATMs”) for authenticating smart, debit and credit card transactions. With the adoption of IC Cars in Europe and the planned roll out of IC Cards in the United States and other countries in the coming years, the dynamic generation of security codes may be easily implemented. When the card holder inserts their card into a IC Card point of sale terminal or inserts their IC Card into an ATM, the card with the dynamically generated security code could automatically generate a new security code after the IC Card completes the transaction. Such an implementation could produce a time and event combination where the card dynamically generates a new security code after a predetermined time period has elapsed and where the card dynamically generates a new security code after a specific event occurs such as when the IC Card is inserted into an IC Card point of sale terminal or ATM.

Protecting the security codes inside the card 400 is important for the overall card system security's interface with the transaction processing network as shown in FIG. 4. Regardless of whether the security codes are calculated by the card 400 or generated when the card 400 is produced and stored into memory pulled out from a list, the security codes should be encrypted to prevent thieves from accessing the internal working hardware and deciphering the securities codes and algorithm. When the security code is calculated, a cryptography key is at risk and should be protected. Also, a listing of keys that are stored in the card's memory should also be encrypted. Once the security code has been generated or recalled from the card's memory, it is displayed on the card 400 and it is no longer a secret anymore. However, the security code that is generated will have a limited life and will only be valid for a predetermined time period.

When a smart, debit or credit card 400 is used with a wireless card reader 402, the wireless card reader acts as a contact-less card reader. In some instances, marketing campaigns proclaim that the card holder taps their card on the card reader. However, what is important is for the card 400 to enter into a close proximity with the card reader 402 such that the RF energy produced by the card reader 402 provides power to the card such that an internal antenna embedded within the card 400 transmits the power to the microprocessor. The microprocessor powers up the RF transmitter which transmits the card's data to the card reader 402.

The RF energy generated by the card reader 402 may also power up an internal light sensor embedded in the card 400 so that when the light sensor detects a predetermined light level the card's microprocessor or RF transmitter is allowed to transmit the card's data to the card reader 402. If the light sensor does not detect any light or the light sensor detects an extremely low amount of light, then the card's microprocessor will determine that the receipt of RF energy was from an unauthorized source and restricts the wireless transmission of card data.

The inclusion of a touch sensitive control button on the card is a way for a card holder to override the blocked transmission of card data if the light sensor does not detect a sufficient amount of light. In such situations such as card use in a dark night club the intended use of the card may be authorized, but the light sensor blocks the wireless transmission of the card data as the card itself decides that the otherwise authorized transaction is an unauthorized transaction. In such scenarios, the card holder could press a touch sensitive control button on the card and the transmission of card data would occur.

FIG. 4 is a block diagram of a card of the data flow when a debit or credit card employing a dynamically generated security code is used to conduct a transaction. When an online or phone transaction is attempted by a card holder, the card information, expiration date, cardholder's name and security code is transmitted to the merchant or organization processing a payment. In other transaction scenarios, a card holder may process a transaction that requires a significant amount of time. Such time consuming transactions include those transactions conducted by fax or mail. Once the merchant receives the card's data at a terminal such as a contactless card reader 402, the card number and zip code are typically verified with the payment processor 404. In some instances the payment processor may be asked to perform the security code authorization such that the payment processor has the capability of authenticating the validity of the card security code.

The payment processor 404 then compares the card holder's card to a list of banned cards and if a match is not made the payment processor 404 passes the card data to the card networks such as Visa, Master Card, American Express, Discover, Europay Maestro, etc. 406 and 408. This card data is then routed to the appropriate network. For example, Visa cards are routed to the Visa network 406 and the Master Cards care routed to the Master Card network 408. Likewise, American Express cards and Europay cards are routed to their respective networks. These card networks 406 and 408 provide security code authorization, zip code authorization and debit and credit the banks Please note smaller banks may push zip code authorization to the card networks or even the payment processor 404. These networks 406 and 408 perform the security code authorization points that are capable of authenticating the validity of the security code as well as interface with various banks 410 to ensure the seamless flow of money and goods when card holders seek to complete transactions.

The same system applies to the implementation of dynamically generated security codes. The bank may issue a card to a customer where the bank sends card holder information to a card issuer who generates a working smart, debit or credit card to the bank's customer. The security code information may be based on information supplied by the payment processor 404 or the card issuer. The security code validation data is supplied to the payment processor 404 so that transactions can be verified and authenticated by the payment processor 404 or the card issuer's network 406 and 408.

When the card enters a RF field generated by a card reader 500, the internal card microprocessor is powered up and the internal card light sensor is powered up and activated 502. If the light sensor detects a predetermined light level 504, then the internal card processor recalls from memory the card data and transmits the card data to the card reader 508. In one embodiment, the processor recalls from memory the security code or alternatively generates a new security code that is transmitted to a card reader. Once the card data is received by the card reader 510, the card reader transmits the card data on a network to the payment processor 512. The payment processor then authorizes the transaction with the card issuer by validating the card data and the security code 514.

FIG. 6 is a block diagram of a smart, debit or credit card with a light sensor controlling the transmission of card data to the card reader. When the card enters a RF energy field generated by a card reader 600, the card uses the RF energy to power up the card's internal microprocessor and activates the internal card light sensor 602. If the light sensor detects a predetermined light level 604, then the internal card processor transmits the card's information to the card reader 606. If the light sensor fails to detect the predetermined light level 604, then the card's processor remains in a standby mode and does not transmit any card data.

In this embodiment, if the card is used in low light conditions, the card holder may be attempting to conduct a valid transaction yet when the light sensor fails to detect the predetermined light level the card intentionally withholds the transmission of card data. In this embodiment, when the light sensor fails to detect the predetermined amount of light 604, the card can initiate a visual signal on the card. If the card is in a card holder's wallet or pursue, the card's visual signal will not be observed and the card stays in a standby mode thus preventing a potential unauthorized transaction.

However, if the card's light sensor fails to detect an appropriate light level, then the card can display a visual signal such turning on an LED light or a visual code can be shown in the display. Upon receiving the visual cue, the card holder or merchant can engage a manual override 608 comprising of pressing a touch sensitive button or entering a PIN number or code so that the card's internal processor recognizes that an authorized transaction is being attempted. If the card was manually activated 610, the card would enable the transmission of card data to the RF card reader 606. If the card was not manually activated 610, then the card's logic would conclude that the transaction was unauthorized and display an error message or service denied message 612. The amount of light level that is needed to engage the transmission of card data is up to the card manufacturer. Many manufacturers may want to set this predetermined level very low, assuming that if the card is in a wallet or purse there will be virtually no light hitting the light sensor. Yet the card could still function in an area of low light such as at a restaurant or night club.

Another alternative embodiment may be the implementation of an event based solution where a light sensor is employed in the RF powered card and the card is capable of dynamically generating new security codes periodically. This periodic generation of new security codes could be accomplished by algorithms or the new security codes could be pre-loaded on the card at the time of issuance and logic within the card recalls the next security code on a list stored in the card's memory and an internal counter within the card is advanced to the next security code in the list. In such an event based implementation, the new security code may be calculated or recalled from a list stored in memory.

In some circumstances, each time the user seeks to use the card, the card holder will press the touch sensitive control button 310 located on the card. When pressed, the card can dynamically generate a security code. This security code will be valid for a predetermined amount of time, e.g. a couple of days or even several weeks. This would enable the cardholder to use the security code in transactions that may take some time to process such as transactions conducted by mail or fax.

In other circumstances, when the user seeks to use the card, the card holder will press the touch sensitive control button 310 and the card will generate a first security code 402. A built in counter within the card increments will increase the value of the counter by one 404 each time the touch sensitive control button 310 is pressed. When the card holder presses the touch sensitive control button a second time a new security code is generated and displayed on the card. The second security code may be used in the next transaction. The card processor then compares the transmitted security code with the security codes stored in their authorization system. If the security codes match, the transaction is authorized and approved. The card processor's authorization system then increments its counter and waits for the next transaction. If the security codes do not match, the transaction is rejected. In an alternative embodiment, the pressing of the touch sensitive control button 310 will generate the same security code over a predetermined time period, e.g. several days or several weeks.

A problem occurs however when a card holder keeps pressing on the touch sensitive control button or when the card activates by itself based on pressures exerted on a wallet and multiple codes are generated without being submitted as a part of a transaction to the payment processor. Under such conditions, whenever a legitimate transaction is attempted by the card holder a de-synchronization issue will arise between the counter inside the card and the counter located on the backend processing side at the payment processor if there is a one-to-one correlation between the security code generated by the counter in the card and the counter used to pull valid security codes from a list located at the card processor or card issuer.

This issue may be counteracted by allowing the card processor or card insurer to validate any security code that is submitted for that particular card. As an alternative, the card processor or card issuer may create a large window of possibly valid security codes submitted by the card. For example, when a security code is submitted for a valid transaction by a cardholder, the card processor or card issuer may create a window that will validate any of the next 50, 100 or even 200 security code entries on the list of valid security codes associated with that card. Assuming this window is 100 values, if the first security code submitted was valid, and the window was 100 values, if the next security code submitted by the card holder was the 89^{th} entry on the security code list, then the transaction would be authorized by the card processor or card issuer. If the next security code submitted was the 105^{th} entry on the security code list, the transaction would be denied and the cardholder instructed to call into the customer service department so that the security card list could be re-synchronized. If the window selected is too large, the probability that a person engaged in fraud may guess a valid security code may rend the security features meaningless. Also, if a card were to fall into the hands of a child, repeated pressing of the touch sensitive control button could quickly cause the counter to become de-synchronized. In these scenarios, the card holder's frustration is likely to rise and the card issuers cost rise as cards become frequently replaced well before their intended expiration or the card holder has to be resynchronized by the card holder on a frequent basis.

FIG. 7 is a block diagram of a display code sequence enabling the use of a dynamically generated security code where the card recalls from memory a stored list of security codes selected by a counter. When the card holder places the card on or near a contactless card reader 700, the card reader transmits RF energy 702 that powers the internal components of the card such as the microprocessor and light sensor 704. Logic operating in the microprocessor queries whether the light sensor detects a predetermined light level or illuminance 706. The predetermined light level is typically established by the card issuer and incorporated into the card's logic during the manufacturing process of the card. If the light level does not reach a certain level of illuminance, then the card does not transmit any card data 708. Such conditions may occur when unscrupulous individuals attempt to steal card data by energizing a card holder's card without the card holder's knowledge of the card being energized in an unauthorized transaction. If the light sensor detects a sufficient amount of illuminance, then the card generates a new security code or retrieves from the card's memory a new security code 710 and transmits 712 the card's data to a card reader. The card may be enabled to display the security code on a card display 714. If the card has no display, the security code would be sent to a wireless card reader along with the card's PAN and the security code is used in the transaction 716.

The card processor or card issue's logic in the card authorization network would determine if the security code received from the card matches the security code in the payment processor's or card issuer's authorization system 718. If the security codes match, the transaction is authorized and the system approves the security code 720. If the security code sent by the card was pulled from a stored list of security codes, a counter logic within the card and card processing network would increment by one value 722. If the security codes do not match, the transaction is rejected 724.

A complication that arises in the implementation of a dynamically generated security code is how long the security code should remain valid. If the security code window of validity is limited to several minutes, online and mail order phone transactions have a high probability of success while faxed transactions or transactions accomplished by mail will nearly always fail. Thus, there needs to be a balance between decreasing the potential for fraud activity and optimizing the types of transactions so that the overwhelming majority of card holder transactions are approved. This time window is best optimized for a validity window of one to two weeks. The determination of the optimum time window is typically selected by the card issuer based on their statistical data for card usage and the level of fraud activity.

FIG. 8 is a block diagram of a simple display code sequence enabling the use of a dynamically generated security code. Using a time based implementation methodology where the security code changes by itself based on a periodic clock event, eliminates the de-synchronization possibility based on inadvertent repeated selection of the touch sensitive control button. When the card is initialized by the card issuer, the card and the backend processing system controlled by the payment processor are synchronized. As added protection, a limited time drift window may be implemented to further reduce potential problems ensuring that the security codes are not out of synchronization. Also, the addition of a time drift solution could eliminate the need for a card holder to select the touch sensitive control button on the card, since the security code could change itself automatically based on input from the internal clock. The only limitation on this solution would be the battery life with the display always on.

A time based methodology for the generation of security codes typically requires the card to have an internal clock or wireless access to a time keeping system so that the generation of security codes are synchronized with the card issuer or payment processor. As an alternative, the card could connect to the payment processor or a third party who maintains a clock for synchronization timing solutions. With a sufficiently long period of time window to deal with transactions that require a longer period of time, e.g. faxed or mail transactions, one security code could be used for multiple transactions that may occur during this time period window.

For the time window, a solution is to have a card capable of generating a new security code that is valid during a periodic time window that is sufficiently large enough to overcome delays that may exist in transactions that require more time, e.g. fax and mail transactions. A typical time window could be as short as one week or as long as one month. In other words, a specific security code will be valid for a fixed period of time and the same security code will be displayed on the card. When the time window expires the card will dynamically generate a new code or recall from memory the next security code from a list of security codes stored on the card. As an alternative embodiment for storing a list of security codes on the card, this list may be stored in the cloud on the card issuer's servers or card processor's servers and called by wireless commands automatically sent from the card to these servers without the card holder knowing that these communication messages are being sent and received by the card. However, a major limitation for such a wireless interface with the cloud is for card holders who may be attempting to conduct a transaction in a remote location where wireless connections are not possible thus when it is time for the card holder to conduct a transaction, no current security code is stored on the card.

In FIG. 8, the security code may be sent by the card to a payment processor for authentication. The security code may be recalled from memory, or recalled from a list stored in the card's memory or automatically generated by algorithms running on the microprocessor located within the card. When the security code is recalled from memory and pulled from a list of security codes or when the security code is automatically generated, the security code is allocated to a time period window. For example, the card may be enabled to dynamically generate a security code 802 that tracks the various time period windows Period 1 (804), Period 2 (806) and Period 3 (808). The security codes that will be generated for each of the time period windows Period 1 (804), Period 2 (806) and Period 3 (808) are 111 (810), 222 (812) and 333 (814) respectively.

The security code 111 (810) is generated by the card and sent to the payment processor's authorization system 816. In some instances, the authorization system may reside with the card issuer. In either event, the card issuer or payment processor card authorization system 816 compares the card's security code 111 (810) to the security code authorized by the card issuer or payment processor's computer systems 816. If the card's security code 111 (810) corresponding to Period 1 (804) matches the card issuer or payment processor's security authorization system 816 security code 111 (820) for Period 1, then the transaction is authenticated and payment is made. Otherwise, payment authorization is declined.

In order to prevent valid codes from being rejected by the card issuer or the payment processor authorization system 816, when a transaction is attempted by a card holder that is close to or just past the time period window for the security code's validity, the card issuer or payment processor authorization system 816 may consider the security code 111 (810) entered by the card holder was sent during the middle of the sliding time period window 818.

The sliding time period window 818 may allow the authorization of multiple values 111 (820) and 222 (822) allowing for various types of transactions by the card holder ranging from fast e-commerce transaction to transactions taking days or a couple of weeks such as those conducted by mail. For example, if a time period window is considered valid for fifteen (15) days and a security code is submitted on the fourteenth (14^{th}) day, the card issuer or payment processor authorization system 816 may match the submitted security code 111 (810) against a first security code 111 (820) that is seven (7) days old and second security code 222 (822) that is seven (7) days in the future. Therefore, this security code matching methodology allows time period window flexibility for slower transactions such as those attempted by fax or mail without increasing otherwise valid transactions from being declined.

A likely scenario is that the time periods between the dynamic generation of security codes will vary between differing card issuer networks. Also, the sliding time period window will also likely differ between the various card issuer networks.

While various embodiments of the invention have been described, it will be apparent to those of ordinary skill in the art that many more embodiments and implementations are possible that are within the scope of this invention.

What is claimed is:

1. A card capable of enabling the wireless transmission of card data, comprising a microprocessor embedded in the card connected to a light sensor embedded in the card where the microprocessor and the light sensor are powered by RF energy received from a card reader.

2. The card capable of enabling the wireless transmission of card data of claim 1, further comprising an antenna connected to the microprocessor.

3. The card capable of enabling the wireless transmission of card data of claim 1, further comprising an antenna connected to the light sensor.

4. The card capable of enabling the wireless transmission of card data of claim 1, further comprising a keypad connected to the microprocessor.

5. The card capable of enabling the wireless transmission of card data of claim 4, further comprising a key pad capable of accepting a PIN code.

6. The card capable of enabling the wireless transmission of card data of claim 1, further comprising a battery connected to the microprocessor and light sensor.

7. The card capable of enabling the wireless transmission of card data of claim 1, further comprising a touch sensitive control button that when pressed sends messages to the microprocessor.

8. The card capable of enabling the wireless transmission of card data of claim 1, further comprising a visual display connected to the microprocessor.

9. The card capable of enabling the wireless transmission of card data of claim 8, further comprising a touch sensitive control button that when pressed enables the microprocessor to display a text message on the visible display.

10. The card capable of enabling the wireless transmission of card data of claim 8, further comprising a touch sensitive control button that when pressed enables the microprocessor to display a security code on the visible display.

11. The card capable of dynamically generating security codes of claim 8, where the viewable display is capable of showing at least three digits.

12. The card capable of dynamically generating security codes of claim 8, where the viewable display further comprises an e-paper type material.

13. The card capable of dynamically generating security codes of claim 1, where the processor, the memory storage area and the battery are embedded within the card.

14. The card capable of dynamically generating security codes of claim 1, further comprising an RF antenna capable of wirelessly connecting the card to a network.

15. The card capable of enabling the wireless transmission of card data of claim 1, where the card is capable of generating a new security code after a predetermined time period has elapsed.

16. The card capable of enabling the wireless transmission of card data of claim 1, where a new security code is generated after an event occurs.

17. The card capable of enabling the wireless transmission of card data of claim 1, where the event is the light sensor detects a predetermined level of illuminance.

18. The card capable of enabling the wireless transmission of card data of claim 1, where the viewable display is mounted in the card and the display is visible to a card holder.

19. The card capable of dynamically generating security codes of claim 10, where the security code is called from a list of encrypted security codes stored in the memory storage area.

28. The card capable of dynamically generating security codes of claim 19, where a subsequent security code is called from an encrypted list of security codes stored in the memory storage area by using a counter that increments each time the security code is called by the card holder.

29. A method for authenticating validity of a card transaction, comprising the steps of:
generating an RF energy field by a card reader;
determining whether an embedded light sensor detects a predetermined light level and if not, preventing the card's embedded microprocessor from powering up.

30. A method for authenticating validity of a card transaction, comprising the steps of:
generating an RF energy field by a card reader;
powering an embedded microprocessor and a light sensor by receiving the RF energy by an embedded antenna connected to the microprocessor and the light sensor; and
determining whether the embedded light sensor detects a predetermined light level and preventing the card from transmitting card data to the card reader if the predetermined light level is not met and allowing the card to transmit the card data if the predetermined light level is met.

30. The method for authenticating validity of the card transaction of claim 29, where the step of determining whether the embedded light sensor detects a predetermined light level allows for transmission of card data to the card reader if the embedded light sensor detects the predetermined light level.

31. The method for authenticating validity of the card transaction of claim 29, further comprising transmitted the card data from the card reader to a card transaction processing network.

32. The method for authenticating validity of the card transaction of claim 29, further comprising sending a signal to the card holder if the predetermined light level is not met.

33. The method for authenticating validity of the card transaction of claim 32, where the signal is a message that is displayed on the card's embedded visual display.

33. The method for authenticating validity of the card transaction of claim 32, where the signal is a visual cue indicating that the predetermined light level was not met.

34. A method for authenticating validity of a card transaction, comprising the steps of:
generating an RF energy field by a card reader;
powering an embedded microprocessor and a light sensor by receiving the RF energy by an embedded antenna connected to the microprocessor and the light sensor;
determining whether the embedded light sensor detects a predetermined light level and preventing the card from transmitting card data to the card reader if the predetermined light level is not met and allowing the card to transmit the card data if the predetermined light level is met; and
obtaining a security code.

35. The method for authenticating validity of a card transaction of claim 34, where the step of obtaining a security code is performed by calling the security code from a list of security codes stored on the card.

36. The method for authenticating validity of a card transaction of claim 34, where the step of obtaining a security code is dynamically generating the security code for a predetermined time period.

37. The method for authenticating validity of a card transaction of claim 36, further comprising the step of creating a first and second time period windows with which the card security code is deemed valid if the card security code matches the network security code associated with the first time period window or the second time period window.

38. The method for authenticating validity of a card transaction of claim 36, further comprising the step of creating a sliding time period window of a predetermined size that creates a mid-point of the sliding time period window associated with the arrival time of the card security code on the card network.

39. The method for authenticating validity of a card transaction of claim 36, further comprising the step of providing authorization of the card security code if the card security code matches the network security codes associated with a first and second time periods that overlap the sliding time period window.
